(19) United States
(12) Patent Application Publication
(10) Pub. No.: US 2011/0041611 A1
(43) Pub. Date: Feb. 24, 2011

(54) METHOD AND APPARATUS FOR RECOGNIZING A BEARING DAMAGE USING OSCILLATION SIGNAL ANALYSIS

(75) Inventors: Joachim Hofer, Munchen (DE); Lutz Leutelt, Berlin (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/990,061

(22) PCT Filed: Apr. 29, 2009
(86) PCT No.: PCT/EP2009/055166

§ 371 Date: Oct. 28, 2010

(30) Foreign Application Priority Data
Apr. 29, 2008 (DE) 10 2008 021 360.8

(51) Int. Cl. G01L 1/10

(52) U.S. Cl. 73/579

(57) ABSTRACT

A device for recognizing bearing damage of a bearing (3), on which an object (4) which rotates at a rotational frequency is mounted, having at least one oscillation sensor (2) for converting an oscillation signal output by the bearing (3) into an electrical signal and having a calculation unit (8) for performing a first frequency transformation for multiple time windows of the oscillation signal to generate multiple time window spectra associated with the particular time windows and for performing a second frequency transformation for multiple frequency bands of the time window spectrograms to generate a multiband modulation spectrum, which, for modulation frequencies which are a function of the rotational frequency of the rotating object (4) because of bearing damage of the bearing (3), have signal amplitudes, the level thereof disclosing an extent of the bearing damage.

The invention relates to a method and an apparatus for recognizing a bearing damage particularly in roller bearings

Ball and/or roller bearings comprise an inner ring and a moveable outer ring, which are separated from one another by rolling elements. Rolling friction mainly occurs between the inner ring, the outer ring and the rolling elements, which are balls for instance. As the rolling elements in the inner and outer ring conventionally roll on hardened steel surfaces with optimized lubrication, the rolling friction of this roller bearing is relatively minimal. A plurality of different roller bearings exist, like for instance ball bearings or taper roller bearings. The service life of ball and/or roller bearings depends on the condition of the bearing, the applied load of the bearing and the maintenance of the bearing. Roller bearings are mostly used in machines to support rotating objects, in particular rotating axes. As a result of wear and/or as a result of an excessively high mechanical load, roller bearings may comprise bearing damage. For instance, the roller elements contained in the roller bearing may be damaged mechanically. As a result of the mechanical damage of the roller bearing, this generates additional oscillation signals and/or noise signals relative to a roller bearing which functions efficiently. This fact is used in conventional apparatuses in order to identify bearing damage of a roller bearing.

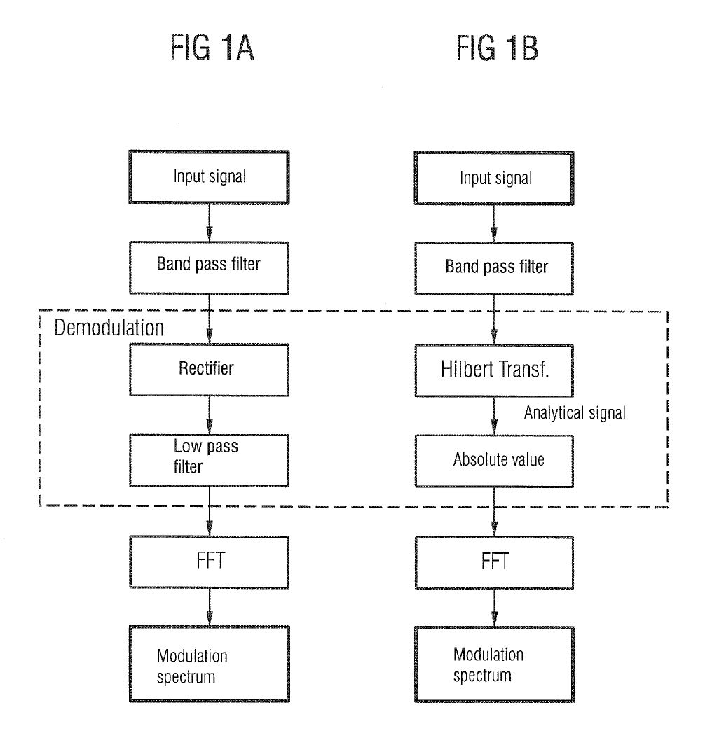

FIGS. 1A, 1B show flow charts to display the procedure in the case of conventional methods for recognizing a bearing damage.

The oscillation signal generated by the bearing is initially detected by an oscillation sensor and converted into an electrical input signal. The input signal is then filtered using a narrow-band band pass filter. In this way the lower and upper cut-off frequency of the band pass filter are selected on the basis of the experience of a user and adjusted accordingly. An amplitude demodulation of the narrow-band signal filtered by the band pass filter then takes place. In the procedure shown in FIG. 1A, a rectification of the band pass-filtered narrow-band signal and a subsequent low pass filtering takes place initially in order to implement the amplitude demodulation. Another conventional procedure for amplitude demodulation consists initially in determining an envelope of the band pass-filtered narrow-band signal, by means of a Hilbert transformation and then in performing an absolute-value generation. The amplitude-demodulated signal is subjected to a Fast-Fourier Transformation (FFT) in a further step, in order to calculate the modulation spectrum. The developed modulation spectrum is then visually examined by a user and/or expert in order to determine whether or not a bearing damage exists.

The conventional procedure shown in FIGS. 1A, 1B for recognizing a bearing damage is nevertheless disadvantageous in that only a modulation spectrum is determined for a specific narrow spectral band, which is defined by a lower and upper cut-off frequency of the selected band pass filter. The adjustment of the cut-off frequencies of the band pass filter relates here to the know-how of a user and/or expert for bearing damage. If the cut-off frequencies of the band pass filter are not correctly adjusted, a possibly existing bearing damage of the bearing cannot be identified in the generated modulation spectrum. The manual adjustment of the band pass filter relates to the wealth of experience of the adjusting user. This manual adjustment is relatively time-consuming on the one hand and can also only be performed by specially trained personnel. A maladjustment of the cut-off frequencies or the attenuation of the band pass filter results in a possibly existing bearing damage not being recognized. If a bearing damage is not recognized promptly, this may result in a malfunction of the entire machine, in which the bearing is integrated.

It is thus an object of the present invention to create a method and an apparatus, in which a developing bearing damage is detected reliably and rapidly.

This object is achieved in accordance with the invention by a method having the features specified in claim 1.

The invention creates a method for recognizing a bearing damage of a bearing having the following steps:
(a) implementing a first frequency transformation for several time windows of an oscillation signal, which is output by a bearing, which supports an object rotating with a rotational frequency, in order to generate several time window spectra associated with the respective time windows.
(b) implementing a second frequency transformation for several frequency bands of the time window spectra in order to generate a multiband modulation spectrum, which has signal amplitudes for modulation frequencies, which depend on the rotational frequency of the rotating object as a result of a bearing damage, the extent of signal amplitudes of which specifies a degree of the bearing damage.

With an embodiment of the inventive method, an oscillation signal generated by the bearing is detected by means of at least one oscillation sensor.

With an embodiment of the inventive method, the oscillation signal is formed by an airborne sound signal or by a solid-borne sound signal.

With an embodiment of the inventive method, the oscillation signal is converted into an electrical signal by the oscillation sensor.

With an embodiment of the inventive method, the analogue electrical signal output by the oscillation sensor is digitalized by an analogue/digital converter.

With an embodiment of the inventive method, a sum of the time window spectrogram which is associated with the respective time windows is formed in accordance with the first frequency transformation.

With an embodiment of the inventive method, the digitalized signal is band pass-filtered.

With an embodiment of the inventive method, the frequency transformation is formed by an FFT transformation.

With an embodiment of the inventive method, the spectrum is formed by a wavelet transformation.

With an embodiment of the inventive method, the multiband modulation spectrum is standardized.

With an embodiment of the inventive method, features for classifying the bearing are automatically extracted from the multiband modulation spectrum.

The invention also creates an apparatus for recognizing a bearing damage with the features specified in claim 12.

The invention creates an apparatus for recognizing a bearing damage of a bearing, which supports an object rotating with a rotational frequency, comprising:
(a) at least one oscillation sensor for converting an oscillation signal output by the bearing into an electrical signal;
(b) one of the calculation units for implementing a first frequency transformation for several time windows of the oscillation signal in order to generate several time window spectra associated with the respective time window and in order to implement a second frequency transformation for several frequency bands of the time window spectra for generating a multiband modulation spectrum, which has signal amplitudes for modulation frequencies, which depend on the rotational frequency of the rotating object as a result of a bearing damage to the bearing, the extent of the signal amplitudes of which specifies a degree of the bearing damage.

With an embodiment of the inventive apparatus, the oscillation sensor is a microphone, an acceleration sensor, an LVDT or a vibrometer.

With an embodiment of the inventive apparatus, the bearing is a roller bearing, which supports a rotating axis.

With an embodiment of the inventive apparatus, a display is provided to display the multiband modulation spectrum.

Furthermore, preferred embodiments of the inventive method and the inventive apparatus for recognizing a bearing damage are described with reference to the appended figures in order to explain features which are essential to the invention, in which;

FIGS. 1A, 1B show flow charts to display conventional methods for recognizing a bearing damage;

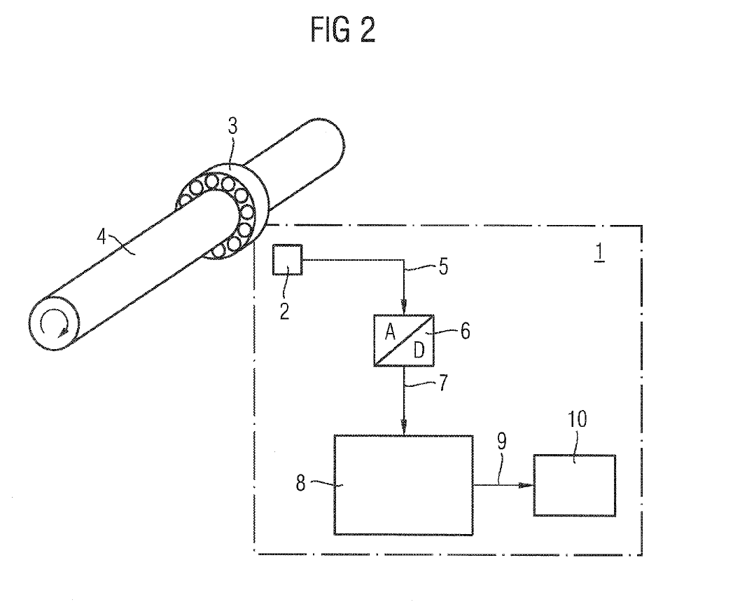

FIG. 2 shows a block diagram of a possible embodiment of the inventive apparatus for recognizing a bearing damage;

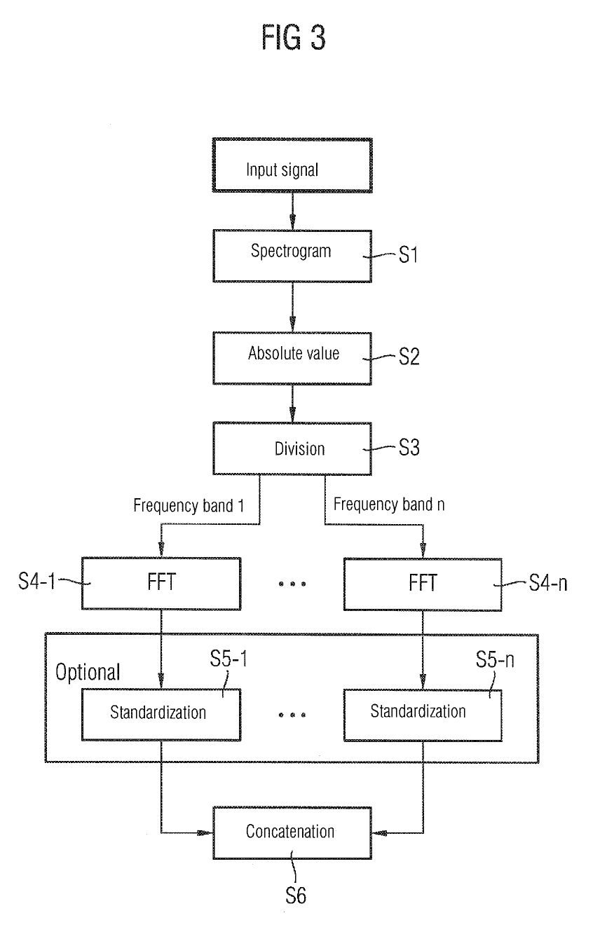

FIG. 3 shows a flow chart for displaying a possible embodiment of the inventive method for recognizing a bearing damage;

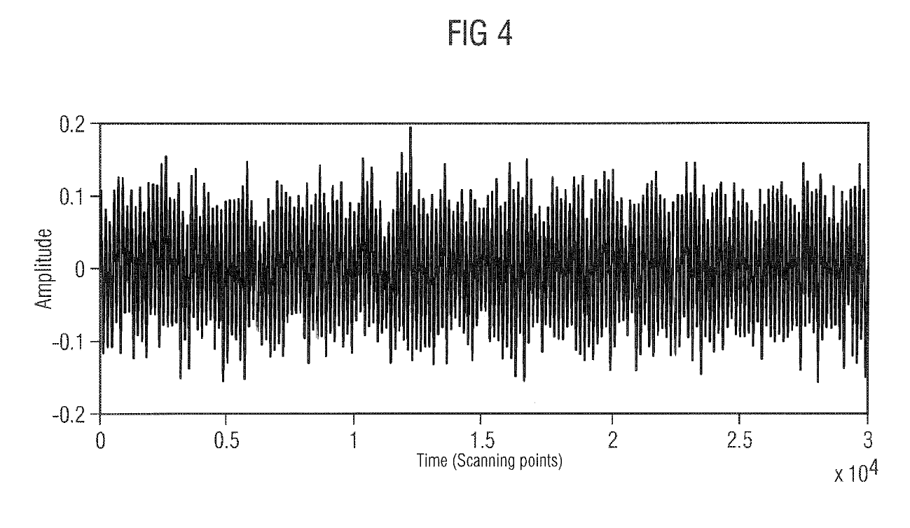

FIG. 4 shows a signal diagram for displaying an oscillation signal detected in the inventive method;

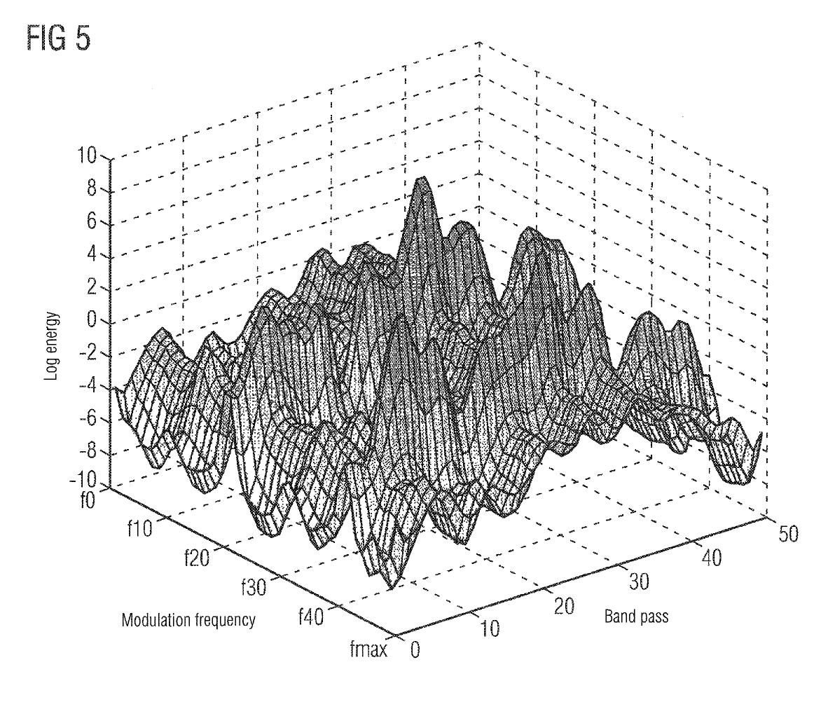

FIG. 5 shows an example of a multiband modulation spectogram generated in the inventive method;

As apparent from FIG. 2, the inventive apparatus 1 for recognizing a bearing damage in the exemplary embodiment shown in FIG. 2 comprises at least one oscillation sensor 2, which converts an oscillation signal output by a bearing 3 into an electrical signal. In the example shown in FIG. 2, the bearing 3 is formed by a roller bearing. The roller bearing 3 supports a rotating object 4, which rotates with a rotational frequency. The rotating object 4 can be a rotating axis for instance, as shown in FIG. 2. In one possible embodiment, the oscillation sensor 2 can be attached directly to the bearing 3, in order to detect solid-borne sound and/or body oscillations. The oscillation sensor 2 can be attached to a housing of a machine, which contains the bearing 3. In an alternative embodiment, the oscillation sensor 2 is distanced from the bearing 3 and detects an airborne sound signal. The oscillation sensor 2 may be a microphone, an acceleration sensor, an LVDT or a vibrometer for instance. The oscillation sensor 2 detects an oscillation signal, in particular an acoustic airborne or solid-borne sound signal. The oscillation signal is converted into an electrical signal and output to an analogue-digital converter 6 by way of a line 5. The analogue-digital converter 6 converts the analogue electrical signal into a digital signal with a scanning frequency. The digitalized signal is output to a calculation unit 8 by way of a line 7. The calculation unit 8 is formed for instance by a microprocessor. The calculation unit 8 implements a first frequency transformation for several time windows of the received digitalized signal. An assigned time window spectrum and/or a spectrogram is generated here for each time window. The first frequency transformation is for instance an FFT transformation or a wavelet transformation. According to an absolute value generation, a second frequency transformation is performed by the calculation unit 8 for several frequency bands of the formed time window spectra in order to generate a multiband modulation spectrum. The multiband modulation spectrum has signal amplitudes for modulation frequencies, which, as a result of a bearing damage to the bearing 3, depend on the rotational frequency of the rotating object 4, the extent of which specifies a degree of the bearing damage. FIG. 5 shows an example of a multiband modulation spectrum of this type. The formed multiband modulation spectrum is output to a display 10 by way of a line 9. In one possible embodiment, an automatic extraction of features from the formed multiband modulation spectrum also takes place by the data processing unit 8 in order to classify the bearing 3. For instance, threshold values are defined, the overwriting of which results in a classification of the bearing 3 as damaged. If the bearing 3 is identified as damaged, in one possible embodiment the calculation unit 8 can output control signals for an error correction. For instance, the calculation unit 8 can automatically switch off a drive for the rotating object 4.

FIG. 3 shows a flow chart of a method for recognizing a bearing damage, which is used as an example to facilitate understanding of the invention. The oscillation signal output by the oscillation sensor 2 is digitalized by the analogue/digital converter 6 and the input signal is fed to the calculation unit 8. The calculation unit 8 implements a windowing of the fed time signal and then, in step S1, calculates an associated time window spectrum for each time window by means of a first frequency transformation. The time window preferably comprises here a predetermined adjustable time duration. A wavelet transformation can be used instead of the spectrogram formation and/or the first Fourier transformation. An advantage of the wavelet transformation consists in the wavelet exhibiting different temporal resolutions for the individual spectral bands. For this reason, the undersampling and the low pass filtering of the demodulated signals is dependent on the frequency of a carrier wave and does not need to be adjusted by the user.

An absolute value formation for each formed time window spectrum is then carried out in step S2. This time window spectrum is then divided into several frequency bands in step S3, with this division taking place for instance by means of several band pass filters. The absolute value calculation of the individually divided frequency bands corresponds to a low pass-filtered and undersampled demodulation, with the cut-off frequency of the low pass filter depending on the window size of the windowed FFT. To determine the spectrum of the modulation, a second frequency transformation is implemented in further steps S4 for each frequency band. This second frequency transformation can be either a fast Fourier transformation or a wavelet transformation. The implementation of the second frequency transformation for the different frequency bands of the time window spectra results in the formation of a multiband modulation spectrum, as shown by way of example in FIG. 5. The multiband modulation spectrum has signal amplitudes for different modulation frequencies f₀, f₁₀, f₂₀, f₃₀, f₄₀, which, as a result of a bearing damage of the bearing 3, depend on a rotational frequency f_{Rot} of the rotating object 4, the degree of which indicates a measure for the extent of the bearing damage. The signal amplitudes of the multiband modulation spectrum indicate the energy of the signal or the signal-to-noise ratio SNR for the different frequencies and frequency bands. With one possible embodiment, a standardization of the formed spectrum takes place after implementing the second frequency transformation, for instance after carrying out an FFT. This standardization can take place by a DC part by means of a division for instance, so that comparisons are simplified. The formed multiband modulation spectrum, as shown by way of example in FIG. 5, is then visualized by means of the display facility 10. The visualization can take place in a two or three dimensional fashion. With a two-dimensional representation, contour lines of the calculated amplitude division are displayed for instance for the different modulation frequencies and the different frequency bands.

With one possible embodiment, associated spectra are calculated in step S4 for the different frequency bands, are standardized in step S5 and are then concatenated in step S6 in order to form the multiband modulation spectrum.

With a further embodiment of the inventive method, an automatic feature extraction of features for subsequent classification of the bearing 3 takes place with the aid of the formed multiband modulation spectrum. Here the bearing 3 can be classified for instance as faulty or as non-faulty.

FIG. 4 shows an example of an input signal, which is fed to the calculation unit 8. This time signal is initially windowed and an associated time window spectrum is calculated for each time window by means of a first frequency transformation. After generation of the absolute value, a division into different frequency bands takes place in step S3, for which a frequency transformation is implemented in each instance for its part. After standardization and concatenation, a multiband modulation spectogram is then formed. It is therefore possible to determine several demodulation spectra at the same time in order to analyze the bearing damage. The inventive method is advantageous in that a frequency band no longer has to be manually selected in order to analyze the bearing 3.

With the inventive method, a plurality of frequency bands are analyzed at the same time. Different faults in the bearing 3, which can manifest themselves in different frequency bands, are identified at the same time in the case of the inventive method and can thus be more easily distinguished from one another. If wavelets are used in the inventive method for demodulation purposes, the temporal and frequency-related division of the signal can be freely determined. The standardization simplifies the comparison of modulation spectra. With one possible embodiment, the classification automatically takes place by means of a classification algorithm.

The standardization then makes the inventive method robust relative to changes in the acoustic channel. If two identical signals are received in rooms with different acoustic properties, the standardized modulation spectra are consequently almost identical, since the different pulse responses can be found again in the DC part of the modulation spectrum.

With one possible embodiment of the inventive apparatus 1, as shown in FIG. 2, the oscillation sensor 2, the analogue-digital converter 6 and the calculation unit 8 are integrated into a component. An integrated oscillation sensor of this type provides an error signal in one possible embodiment in the event of bearing damage.

1.-15. (canceled)

16. A method for recognizing bearing damage of a bearing, comprising the steps of:
transforming with a first wavelet transformation in a plurality of time windows an oscillation signal generated by the bearing, which supports an object that rotates with a rotational frequency, from a time domain into a frequency domain, to generate a plurality of time window spectra, with each time window spectrum associated with a corresponding time window; and
generating with a second wavelet transformation from several frequency bands of the plurality of time window spectra a multiband modulation spectrum having modulation frequencies, which depend on a rotational frequency of the rotating object, and signal amplitudes, which depend on a degree of the bearing damage.

17. The method of claim 16, further comprising the step of detecting the oscillation signal generated by the bearing with at least one oscillation sensor.

18. The method of claim 16, wherein the oscillation signal is formed by an airborne sound signal or by a solid-borne sound signal.

19. The method of claim 17, wherein the least one oscillation sensor converts the oscillation signal into an electrical signal.

20. The method of claim 19, wherein the electric signal is an analog electrical signal, further comprising the step of digitizing said analog electrical signal with an analog/digital converter to generate a digitized signal.

21. The method of claim 16, further comprising the step of forming, subsequent to the first wavelet transformation, a magnitude of the plurality of time window spectra.

22. The method of claim 20, wherein the digitized signal is band pass-filtered.

23. The method of claim 16, wherein the multiband modulation spectrum is normalized.

24. The method of claim 16, further comprising the step of automatically extracting features from the multiband modulation spectrum for classifying the bearing.

25. Apparatus for identifying bearing damage of a bearing which supports an object that rotates with a rotational frequency, said apparatus comprising:
at least one oscillation sensor converting an oscillation signal outputted from the bearing into an electrical signal; and
a calculation unit configured to
transform with a first wavelet transformation in a plurality of time windows the oscillation signal from a time domain into a frequency domain, to generate a plurality of time window spectra, with each time window spectrum associated with a corresponding time window;
generate with a second wavelet transformation from several frequency bands of the plurality of time window spectra a multiband modulation spectrum having modulation frequencies, which depend on a rotational frequency of the rotating object, and signal amplitudes, with a level of the signal amplitudes depending on a degree of the bearing damage.

26. The apparatus of claim 25, wherein the oscillation sensor is selected from the group consisting of a microphone, an acceleration sensor, a linear variable differential transformer (LVDT), and a vibrometer.

27. The apparatus of claim 25, wherein the bearing is constructed as a roller bearing which supports a rotating axis.

28. The apparatus of claim 25, further comprising a display for displaying the multiband modulation spectrum.
